(19) United States
(12) Patent Application Publication
(10) Pub. No.: US 2010/0032256 A1
(43) Pub. Date: Feb. 11, 2010

(54) OSCILLATION DAMPER, ESPECIALLY FOR MOUNTING ON A MOTOR VEHICLE SEAT

(75) Inventors: Wolfgang Wieser, Kraiburg (DE); Franz Kobus, Jettenbach (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: SGF Suddeutsche Gelenkscheibenfabrik & Co. KG, Waldkraiburg (DE)

(21) Appl. No.: 11/917,351

(22) PCT Filed: May 11, 2006
(86) PCT No.: PCT/EP2006/004443

§ 371 Date: Feb. 7, 2008

(30) Foreign Application Priority Data
Jun. 14, 2005 (DE) 10 2005 027 46834

(51) Int. Cl. F16F 7/108

(52) U.S. Cl. 188/380

(57) ABSTRACT

The invention relates to a vibration damper (10), in particular for attachment to a motor vehicle seat, with a carrier element (12), a vibration mass (14) and a spring arrangement (20), wherein the carrier element (12) and the vibration mass (14) are coupled to one another via the spring arrangement (20). In this vibration damper it is envisaged that the spring arrangement comprises an elastic connection element (20), which joins the carrier element (12) and the vibration mass (14) to one another and is arranged in the region of the centre of gravity (S) of the vibration mass (14).

The present invention relates to a vibration damper, in particular for attachment to a motor vehicle seat, with a carrier element, a vibration mass and a spring arrangement, wherein the carrier element and the vibration mass are coupled to one another via the spring arrangement.

It is generally known that vibrations can occur in motor vehicles due to travel movements as well as external influences, such as unevennesses in the road surface or other periodic or impact-like stresses. These vibrations are transmitted from the body of the vehicle to various vehicle components and act inter alia on the passengers in the vehicle. Such vibrations can on the one hand lead to undesirable noise inside the vehicle, and on the other hand, even without any noise stress, can adversely affect the comfort of passengers in a motor vehicle. Attempts have therefore already been made in the automobile industry as regards the construction of vehicles to counteract the occurrence of vibrations or to suppress these after their formation. Various approaches are employed in this respect. One possible solution to this problem consists in providing individual vehicle components with a high degree of rigidity and a high moment of inertia, in order to reduce their susceptibility to vibration. This runs counter however to the general aim of a lightweight construction, which leads to savings in weight and thereby also to a reduced fuel consumption of the vehicle. An alternative way of avoiding the solid construction approach is to greatly dampen vibrations occurring in lightweight components. For this purpose vibration dampers are used in vehicle construction technology. These vibration dampers are attached to components of the vehicle susceptible to vibration and are excited by the vibrating vehicle components to execute an intrinsic vibration. The intrinsic vibration occurs as a rule in opposite phase to the undesired vibration of the vehicle component, which ultimately leads to a reduction in the vibration. One also speaks of a vibration damping.

It has been shown that such vibrations also occur in motor vehicle seats and have to be suppressed. In recent times components of entertainment systems, such as for example flat screens for a DVD or TV system, have been installed in the backrests of motor vehicle seats, especially in top of the range models, so that the rear passengers can view these screens. However, it is necessary particularly with such types of vehicle to suppress vibrations of the seat rest caused by vibrations occurring in the vehicle, in order on the one hand to reduce the mechanical stresses acting on the screen so as to increase the service life of the latter, and on the other hand to increase the viewing comfort by avoiding a “shaking movement”.

Vibration dampers that can be integrated in motor vehicle seats are already known from the prior art. Thus, for example, the document DE 103 27 711 A1 shows a vibration damper of the type identified in the introduction which can be arranged in a motor vehicle seat. This vibration damper is provided with a frame structure, which can be coupled via a hoop arrangement to a leaning frame of the vehicle seat. Within the frame structure a vibration mass is arranged, which is connected via a spring arrangement to the said frame structure. The vibration mass is of elongated shape and is provided at its ends with a recess. The recess accommodates spring elements of complicated shape. The spring elements are made of elastomeric material and at one end are vulcanised into plastic rings, and at the other end are connected by vulcanisation to a securement bolt. The plastics rings are then pressed into the recess of the vibration mass. The end of the spring elements provided with the bolt is then inserted into the carrier structure of the vibration damper. On account of the relatively complicated construction of this vibration damper, a large number of installation steps are required in order finally to prepare this for attachment to a leaning frame. Moreover, this vibration damper suffers from the problem of a high susceptibility to failure, since on account of the large number of mechanical connections, for example the connection between the vibration mass and frame structure to be effected during the installation, there is a relatively high probability that two components will become dislocated relative to one another on account of the occurring vibrations, and therefore the functioning of the vibration damper will be impaired or basically disturbed.

A similar vibration damper is known from the document DE 103 27 770 A1. This vibration damper too suffers from the problem that it consists of a large number of parts, which require a relatively complicated and therefore cost-intensive installation and furthermore increase the susceptibility to failure.

Furthermore, a vibration damper is known from the patent application filed by the Applicants on 26 Apr. 2005 having the official file reference DE 10 2005 019 323.4, in which the vibration mass is held via a spring arrangement in a carrier frame. With this arrangement vibrations are damped in preferred vibration directions. In addition, this arrangement is relatively heavy.

As regards further prior art reference is made to the document DE 199 08 916 A1.

The object of the present invention is to provide a vibration damper of the type identified in the introduction, which being easier and cheaper to produce offers a high degree of reliability and long service life combined with a good vibration damping capability, but however weighs less.

This object is achieved by a vibration damper of the type identified in the introduction, in which the spring arrangement comprises an elastic connection element which joins the carrier element and the vibration mass to one another and is arranged in the region of the centre of gravity of the vibration mass. Due to this measure it can be ensured that the elastic connection element of the spring arrangement is positioned exactly where forces of inertia act when the vibration mass is excited. Such a positioning of the elastic connection element in the region of the centre of gravity of the vibration mass enables undesirable lever effects to be avoided, which can occur in particular if the elastic connection element is arranged at a significant distance from the centre of gravity of the vibration mass. In this way undesired tumbling movements of the vibration mass which are triggered by vehicle vibrations can be suppressed. Finally, an effective and predictable vibration behaviour can be achieved by the arrangement according to the invention.

Furthermore, the invention envisages that, although the vibration damper is produced from the three individual components—carrier element, vibration mass and spring arrangement—these three individual components are however joined to one another in a quasi-integral manner, so that in the subsequent installation, for example on a leaning frame of a motor vehicle seat, the vibration damper can be installed as a structural part, and that also in subsequent operation, on account of the integral design of the vibration damper no undesired displacement of individual components on account of the acting mechanical stresses can occur. Due to the integral design of the vibration damper the installation effort can be substantially reduced compared to the prior art and the reliability can be significantly improved.

In a modification of the invention it is envisaged that the elastic connection element is produced from an elastomeric material, preferably from natural rubber, and is in each case vulcanised on the carrier frame and on the vibration mass. It is understood that the connection element can also be produced from an elastomeric material other than natural rubber. Due to the vulcanising of the connection elements on the carrier element and vibration mass, the vibration damper has the advantageous configuration of an integral structural part, which despite the mechanical stresses, in particular vibrational stresses occurring during operation, does not undesirably deform. In addition the vibration damper is considerably easier to produce. The carrier element and the vibration mass are in this connection placed in a pre-fabricated mould, and the elastomeric material is then injected into the mould by an injection method and vulcanised onto the carrier element and the vibration mass. The elastic connection elements of the spring arrangement are also formed at the same time.

According to an advantageous embodiment of the invention, it is envisaged that the elastic connection element includes a cylindrical, in particular substantially circular cylindrical, strut member. The design as a cylindrical, in particular circular cylindrical, strut member has the advantage that the connection element has substantially the same vibration behaviour in all vibration directions which run in a plane orthogonal to the cylindrical longitudinal axis. However, the connection element can also have a different geometry, for example in order to promote vibrations in certain directions but to suppress vibrations in other directions. By employing a cylindrical strut member it is possible for the centre of gravity of the vibration mass to lie substantially on the axis of symmetry of the circular cylinder. In general the invention then achieves a good result for example if the shear centre of the connection element, in particular of the strut member, is arranged close to the centre of gravity of the vibration mass or coincides therewith. Undesirable tumbling movements (bending mode) of the vibration mass can be effectively prevented specifically with such an arrangement.

A further development of the invention envisages that the connection element is arranged in such a way between the vibration mass and carrier element that it is subjected to tractive forces due to the vibration mass in the rest state. Alternatively, it can be envisaged that the connection element is arranged in such a way between the vibration mass and carrier element that it is subjected to pressure by the vibration mass in the rest state. In other words, in the first variant it is envisaged that the vibration mass is suspended via the connection element on the carrier element, whereas in the second variant the vibration mass is supported by the connection element on the carrier element. Depending on which of these two alternatives is chosen, different intrinsic frequencies of the vibration damper can be achieved in the longitudinal direction of the connection element. In this way a desired vibration behaviour can be established by a suitable choice of one of the two types of vibration damper.

It has been found that in particular vibrations with very low frequencies are difficult to damp. The vibration damper according to the invention was designed specifically for this particular case. Thus, for the vibration damper according to the invention it is envisaged that it has an intrinsic frequency in the range from 6 to 18 Hz, preferably from about 9 to 14 Hz. Moreover, for the vibration dampers according to the invention it is preferred if the vibration mass at an excitation amplitude of greater than or equal to 0.2 mm produces a vibration mass amplitude of 0 to 5 mm.

In an advantageous embodiment of the invention it is envisaged that the carrier element has a C-arcuate shape. This has the advantage that the carrier element can be of lightweight construction. Obviously however, more solid carrier elements with a different profile can also be employed.

A modification of the invention envisages that the vibration mass is provided with a central recess into which a free end of the carrier element projects, wherein the carrier element in the region of this free end is coupled via the connection element to the vibration mass. This arrangement has the advantage that, due to the configuration of the vibration mass with a recess, the overall weight of the vibration damper can be reduced, though the damping effect remains substantially unaltered. In addition, this arrangement specifically provides according to the invention the possibility of arranging the elastic connection element in the region of the centre of gravity of the vibration mass.

A particularly inexpensive but nevertheless sufficiently stable configuration of the carrier element is then for example provided if the carrier element and/or the vibration mass are produced from a sheet metal material.

In order to improve the reliability of the vulcanised connection on the carrier element and/or on the vibration mass, a modification of the invention envisages that the carrier element and/or the vibration mass is/are pretreated so as to facilitate an integral forming of the connection elements by vulcanisation.

It may furthermore be envisaged according to the invention for the vibration mass to include a metal body, preferably of a cast material. This has the advantage that the vibration mass can be arbitrarily designed as regards its geometry and can be adapted to the respective specific case.

An advantageous modification of the invention envisages that the metal body is provided, at least over certain regions, with a coating, preferably of elastomeric material. Advantageously it is envisaged that the coating is produced when the connection elements are vulcanised on. As has already been mentioned hereinbefore, the vibration damper according to the invention can be produced by placing the carrier element and the vibration mass in a mould, into which the elastomeric material is then injected by an injection process. Advantageously in this connection the mould is configured so that during the injection of the elastomeric material a skin of elastomeric material, for example of about 1 mm wall thickness, is formed around the metal body of the vibration mass. This has the result that the metal body of the vibration mass is surrounded by a damping coating, so that in the event of an extreme deflection of the vibration mass, in which this comes into contact with surrounding structural parts, for example with the carrier element, the impact is damped and no loud impact noise can be produced.

The invention is described by way of example hereinafter with the aid of the accompanying drawings, in which:

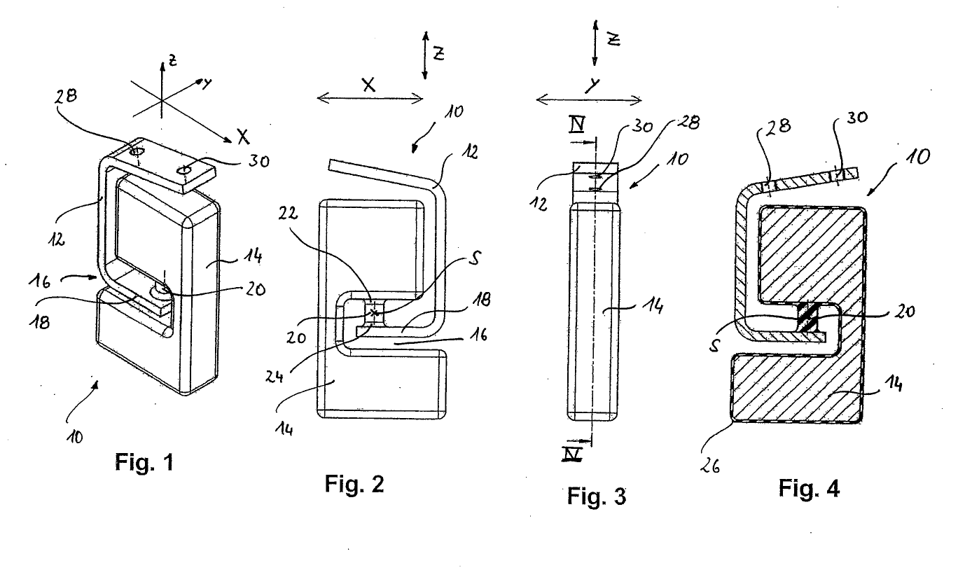

FIG. 1 is a perspective view of a first implementation variant of the vibration damper according to the invention;

FIG. 2 is a front view of the vibration damper according to FIG. 1;

FIG. 3 is a side view from the left of the vibration damper of FIG. 1;

FIG. 4 is a sectional view along the sectional line IV-IV of FIG. 3;

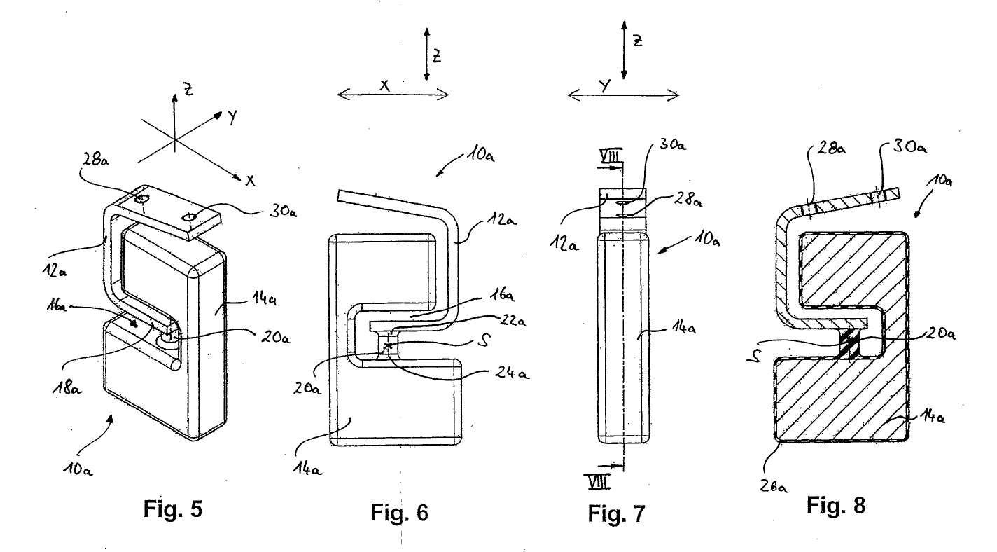

FIG. 5 is a view corresponding to FIG. 1 of a second implementation variant of the vibration damper according to the invention;

FIG. 6 is a view according to FIG. 2 of the second implementation variant;

FIG. 7 is a view according to FIG. 3 of the second implementation variant; and

FIG. 8 is a sectional view along the sectional line VIII-VIII of FIG. 7.

A first embodiment of a vibration damper 10 according to the invention is illustrated in FIGS. 1 to 4. FIG. 1 shows the vibration damper 10 according to the invention in a perspective view. The vibration damper comprises a C-shaped carrier element 12 as well as a vibration mass 14. The vibration mass 14 has a central recess 16, into which projects a free end 18 of the carrier element 12. On the free end 18 is arranged an elastic connection element 20, which connects the vibration mass 14 to the carrier element 12. The connection element 20 is made of elastomeric material and is vulcanised on the vibration mass 14 as well as on the carrier element 12. The connection element 20 has a substantially circular cylindrical shape and transforms smoothly, with the avoidance of sharp edges, into vulcanised-on elastomer sections 22 and 24. The connection element may however also be of different cylindrical shapes.

As can be seen in the sectional view according to FIG. 4, the vibration mass 14 is formed as a homogeneous body from grey cast iron, and is enclosed substantially by an elastomeric skin 26. The elastomeric skin 26 transforms smoothly into the connection element 18 and is likewise vulcanised on the vibration mass 14. All transitions, in particular from the elastomeric skin 26 to the connection element 20, are harmoniously configured. The geometry of the vibration mass 14 and the arrangement of the connection element 20 are chosen so that the shear centre of the elastomeric connection element substantially coincides with the centre of gravity S of the vibration mass. The connection element 20 connects the vibration mass 14 to the carrier element 12 in such a way that the vibration mass 14 via the connection element 20 exerts a force on the free end 18 of the carrier element 12. This means that when the vibration damper 10 is secured in the illustrated orientation via securement holes 28 and 30 in the slightly slanting upper arm of the C-shaped carrier element 12, the connection element 20 in the rest state is subjected to a pressure by the vibration mass 14.

In such an arrangement of the vibration damper 10 according to FIGS. 1 to 4, for example within a motor vehicle seat, vibrations can be damped in the X direction as well as in the Y and Z directions. The essential feature of the invention is that the elastomeric connection element 20 is arranged in the region of the centre of gravity S of the vibration mass 14. Due to this positioning of the elastomeric connection element 20, undesirable tumbling movements of the vibration mass 14 can be avoided. One elastomeric connection element 20 is sufficient to damp vibrations in all three spatial directions X, Y and Z. This means that the vibration damper 10 according to the invention is highly effective despite being of relatively simple construction. Due to this simple construction the overall mass of the vibration damper can be kept relatively low while providing a good damping effect. In particular, a considerable reduction in mass of those components can be achieved that do not contribute directly to the damping action, such as for example on the carrier element 12. Although the vibration damper 10 according to the invention is largely covered with elastomeric material, the overall need for elastomeric material is relatively low since the surfaces to be covered can also be kept small due to the simple design and construction.

Obviously the geometry of the vibration mass 14 can be chosen depending on requirements, in which connection the basic concept of the design of the vibration mass with a central recess 16 is furthermore retained.

FIGS. 5 to 8 show a second implementation variant of the invention. In the description of this second embodiment the same reference numerals are used as were employed in the description of the first embodiment according to FIGS. 1 to 4, but with the addition of the letter “a”. Only the differences with respect to the first embodiment according to FIGS. 1 to 4 will be discussed.

The basic difference between the first and second embodiments of the invention is that the vibration mass 14a is suspended at the free end 18a of the carrier element 12a via the connection element 20a, and does not rest on the latter. In other words, the connection element 20a in the embodiment according to FIGS. 5 to 8 is subjected to tractive forces in the rest state, with the result that the vibration damper 10a according to FIGS. 5 to 8 exhibits a different behaviour as regards vibrations in the Z direction, than the vibration damper 10 according to FIGS. 1 to 4. Also, the geometry of the vibration mass 14a differs from the geometry of the vibration mass 14 according to the first embodiment, and specifically in that the central recess 16a is located somewhat higher within the vibration mass 14a. The reason for this is that the elastomeric connection element 20a is in turn arranged in the region of the centre of gravity S of the vibration mass 14a.

In operation vibrations occur in the direction of the spatial axes X, Y and Z for example on a leaning frame (not shown) of a motor vehicle seat, on which the vibration damper 10/10a is arranged. Such vibrations have in particular relatively low frequencies, for example in the region of less than 20 Hz, and excitation amplitudes in the range from 0.2 mm to 1 mm. These vibrations are transmitted via the carrier element 12/12a and the connection element 20/20a to the vibration mass 14/14a. The vibration mass 14/14a is thereby excited to perform a vibrational movement of opposite phase, and specifically in all three direction components X, Y and Z, whereby the elastic connection element 20/20a yields elastically. The connection element is thereby subjected to a parallel axial load in the X-Y direction, the shear centre preferably coinciding with the centre of gravity S of the vibration mass 14/14a. A tractive/compressive loading of the connection element 20/20a occurs in the Z direction. Due to the counter-phase vibration movement of the vibration mass 14/14a, the vibrations occurring on the leaning frame (not shown) are damped. The intrinsic vibration frequency of the vehicle seat is thus damped and the seat therefore vibrates much less intensively. In addition the components connected to the seat rest, for example the screen of a vehicle entertainment system, are subjected to less powerful vibration stresses. Their service life can thereby be significantly increased. Moreover, there is no annoying shaking movement of the screen when viewing the entertainment program.

The essential advantages of the vibration damper 10/10a according to the invention are the fact that the damper has very low intrinsic frequencies, for example in the range from 6 to 18 Hz, preferably in the range from 9 to 14 Hz. In addition the vibration mass 14/14a of the vibration damper 10/10a according to the invention can handle relatively large amplitudes during the vibration movement, for example in the range from 0 to 5 mm, which leads to a particularly effective vibration damping. A further advantage of the solution according to the invention is that, due to the rubber coating of the vibration mass 14/14a, under extreme vibration movements, in which the vibration mass 14/14a, strikes the carrier element 12/12a for example, no undesired noise can occur. Overall the invention provides a vibration damper that is simple to produce, with a relatively low overall weight and a high vibration damping efficiency combined with a long service life.

1. Vibration damper (10; 10a), in particular for attachment to a motor vehicle seat, comprising:
a carrier element (12; 12a),
a vibration mass (14; 14a) and
a spring arrangement (20; 20a),
wherein the carrier element (12) and the vibration mass (14; 14a) are coupled to one another via the spring arrangement (20; 20a), characterised in that the spring arrangement comprises an elastic connection element (20; 20a) of an elastomeric material, which connects the carrier element (12; 12a) and the vibration mass (14; 14a) to one another and is arranged in the region of the centre of gravity (S) of the vibration mass (14; 14a).

2. Vibration damper (10; 10a) according to claim 1, characterised in that the elastic connection element (20; 20a) is vulcanised respectively on the carrier element (12; 12a) and on the vibration mass (14; 14a).

3. Vibration damper (10; 10a) according to claim 1, characterised in that the elastic connection element (20; 20a) includes a cylindrical, in particular substantially circular cylindrical, strut member.

4. Vibration damper (10; 10a) according to claim 1, characterised in that the shear centre of the connection element is arranged close to the centre of gravity (S) of the vibration mass (14; 14a) or coincides therewith.

5. Vibration damper (10) according to claim 4, characterised in that the connection element (20) is arranged between the vibration mass (14) and carrier element (12) so that it is subjected to tractive forces by the vibration mass (14) in the rest state.

6. Vibration damper (10a) according to claim 4, characterised in that the connection element (20a) is arranged between the vibration mass (14a) and carrier element (12a) in such a way that it is subjected to pressure by the vibration mass (14a) in the real state.

7. Vibration damper (10; 10a) according to claim 1, characterised in that the vibration damper (10; 10a) has an intrinsic frequency in the range from 6 to 18 Hz, preferably from about 9 to 14 Hz.

8. Vibration damper (10; 10a) according to claim 1, characterised in that the vibration mass (14; 14a) at an excitation amplitude of greater than or equal to 0.2 mm ensures a vibration mass amplitude of 0 to 5 mm.

9. Vibration damper (10; 10a) according to claim 1, characterised in that the carrier element (12; 12a) is of C-shaped design.

10. Vibration damper (10) according to claim 1, characterised in that the vibration mass (14; 14a) is provided with a central recess (16; 16a), into which projects a free end (18; 18a) of the carrier element (12; 12a), wherein the carrier element (12; 12a) is coupled in the region of this free end (18; 18a) via the connection element (20; 20a) to the vibration mass (14; 14a).

11. Vibration damper (10; 10a) according to claim 1, characterised in that the carrier element (12; 12a) and/or vibration mass (14; 14a) is/are produced from a sheet metal material.

12. Vibration damper (10; 10a) claim 1, characterised in that the carrier element (12; 12a) is pretreated so as to facilitate an integral forming of the connection element (20; 20a) by vulcanisation.

13. Vibration damper (10; 10a) according to claim 1, characterised in that the vibration mass (14; 14a) includes a metal body, preferably of a cast material.

14. Vibration damper (10; 10a) according to claim 13, characterised in that the metal body is provided at least in certain regions with a coating, preferably of elastomeric material (26; 26a).

15. Vibration damper (10; 10a) according to claim 14, characterised in that the coating (26; 26a) is produced when the connection element (20; 20a) is vulcanised on.
